(19) United States
(12) Patent Application Publication
(10) Pub. No.: US 2007/0242306 A1
(43) Pub. Date: Oct. 18, 2007

(54) IMAGE STORAGE SYSTEM AND IMAGE FORMING SYSTEM

(76) Inventor: Katsuyuki TODA, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/696,437

(22) Filed: Apr. 4, 2007

(30) Foreign Application Priority Data
Apr. 13, 2006 (JP) 2006-111251

(51) Int. Cl. G06K 15/00

(52) U.S. Cl. 358/1.16

(57) ABSTRACT

A printing device is directly connected to a digital still camera via a USB and connected to a host PC over the Ethernet. Image data captured by the digital still camera is stored in a memory card and is directly transferred to the printing device using a specific communication format that enables direct printing. The printing device either carries out a direct-printing printing process or stores the image data in a storage device by imitating the direct-printing printing process. When storing the image data, the printing device creates hypertext links, associating each image data with its storage location, thereby enabling the image data to be viewed or printed from a Web client of the host PC.

### CROSS-REFERENCE TO RELATED APPLICATIONS

The present document incorporates by reference the entire contents of Japanese priority document, 2006-111251 filed in Japan on Apr. 13, 2006.

### BACKGROUND OF THE INVENTION

1. Field of the Invention

The present invention relates to a technology for storing, managing, or printing of image data.

2. Description of the Related Art

Digital still cameras have become widely prevalent as a means for capturing images and creating image data. The image data is generally stored on a memory card in the digital still camera. When printing or viewing an image, corresponding image data is downloaded from the memory card of the digital still camera to a personal computer (PC). The downloaded image data is displayed and/or processed by using application software in the PC, and output via a printer driver to a printer device connected to the PC.

However, most users find it a hassle to send image data in the digital still camera to the printer via the PC, finding operating the image printout application, setting up the printer driver, etc. bothersome.

Therefore, to avoid the use of the PC in the printing process, direct printing systems were introduced that allow the digital still camera to be directly connected to the printer, i.e., without using a PC. The direct printing system thus is an interface that enables image data in the digital still camera to be directly printed out. Digital still cameras and printers that support the interface are available in the market.

For example, a technology has been disclosed in Japanese Patent Application Laid-open No. 2004-64740 that enables direct printing when a digital camera and a printer are directly connected and follow a predetermined process procedure.

Similarly, a technology has been disclosed in Japanese Patent Application Laid-open No. 2004-9389 in which a digital camera and a printer are directly connected, and the image data captured in the digital camera are printed out or managed by the printer.

However, the direct printing interface by itself is essentially for outputting images in the form of printouts and not for viewing the images. A PC still needs to be used for viewing the images. Often exclusive software is required for downloading the images from the digital camera to the PC. Installation of exclusive software is possible if the PC is for personal use. Installation of any new software is usually forbidden, however, on the PCs in organizations for security reasons or for convenience in software management.

Usually, a specific PC is used for downloading the image data from the digital camera. If a user wants to view or print the image data, the user needs to access the PC using a means of some kind. It becomes particularly inconvenient if the PC happens to be shared by a plurality of persons or is mainly used by an individual, because it requires consensus on how to manage access.

The advantage of managing image data on a PC is that exclusive software for management of image data can be used for improved image searching or other processes. However, again, installation of such software is usually forbidden on an office PC.

### SUMMARY OF THE INVENTION

It is an object of the present invention to at least partially solve the problems in the conventional technology.

According to an aspect of the present invention, an image storage system that includes an external storage device that stores therein image data and outputs the image data, and an image storage device that stores therein the image data received from the external storage device by exchanging a specific communication format when the external storage device and the image storage device are directly connected, wherein the image storage device includes a communication control unit that controls communication between the image storage device and the external storage device; a storage unit that stores therein image data received from the external storage device through the communication control unit; and a hypertext creating unit that creates hypertext links associating each image data and a storage location of the image data when storing the image data received from the external storage device in the storage unit.

According to an aspect of the present invention, an image forming system that includes an image storage system that includes an external storage device that stores therein image data and outputs the image data; and an image storage device that stores therein the image data received from the external storage device by exchanging a specific communication format when the external storage device and the image storage device are directly connected, the external storage device being directly connected to the image storage device. The image storage device includes a communication control unit that controls communication between the image storage device and the external storage device; a storage unit that stores therein image data received from the external storage device through the communication control unit; a hypertext creating unit that creates hypertext links associating each image data and a storage location of the image data when storing the image data received from the external storage device in the storage unit; a print-command analyzing unit that analyzes a print command issued in the specific communication format by the external storage device; an image-storage control unit that stores the image data received from the external storage device in the storage unit according to a printing process procedure of the print command analyzed by the print-command analyzing unit; and an image output unit that prints out the image data received from the external storage device, wherein the print-command analyzing unit analyzes the print command issued in the specific communication format by the external storage device and the image output unit prints out the image data received from the external storage device.

According to still another aspect of the present invention, an image forming system that includes an image storage system that includes an external storage device that stores therein image data and outputs the image data; and an image storage device that stores therein the image data received from the external storage device by exchanging a specific communication format when the external storage device and the image storage device are directly connected, the external storage device being directly connected to the image storage device. The image storage device includes a communication control unit that controls communication between the image storage device and the external storage device; a storage unit that stores therein image data received from the external storage device through the communication control unit; a hypertext creating unit that creates hypertext links associating each image data and a storage location of the image data when storing the image data received from the external storage device in the storage unit; a print-command analyzing unit that analyzes a print command issued in the specific communication format by the external storage device; an image-storage control unit that stores the image data received from the external storage device in the storage unit according to a printing process procedure of the print command analyzed by the print-command analyzing unit; an image output unit that outputs the image data received from the external storage device; and a Web-service control unit that connects the image storage device and an external host device over a network and enables the image storage device to function like a Web server, and provides, upon request from a Web client of the external host device, the hypertext links created when storing the image data in the storage unit to the Web client of the external host device, wherein an arbitrary image data stored in the storage unit can be directly output by the image output unit upon request from the Web server of the external host device.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an image storage device used in an image storage system and an image forming system according to an embodiment of the present invention;

FIG. 2 is a schematic for explaining the image storage system and the image forming system in which the image storage system shown in FIG. 1 is configured as a printing device;

FIG. 3 is an exemplary file structure in a directory where image data is stored;

FIG. 4 is an exemplary display screen of a host PC displaying an html document that can be viewed using a Web client; and

FIG. 5 is an exemplary print setup screen that is displayed upon clicking a Print button in the display screen shown in FIG. 4.

### DETAILED DESCRIPTION OF THE PREFERRED EMBODIMENTS

Exemplary embodiments of the present invention are described below with reference to the accompanying drawings. The present invention is not limited to the embodiments described below.

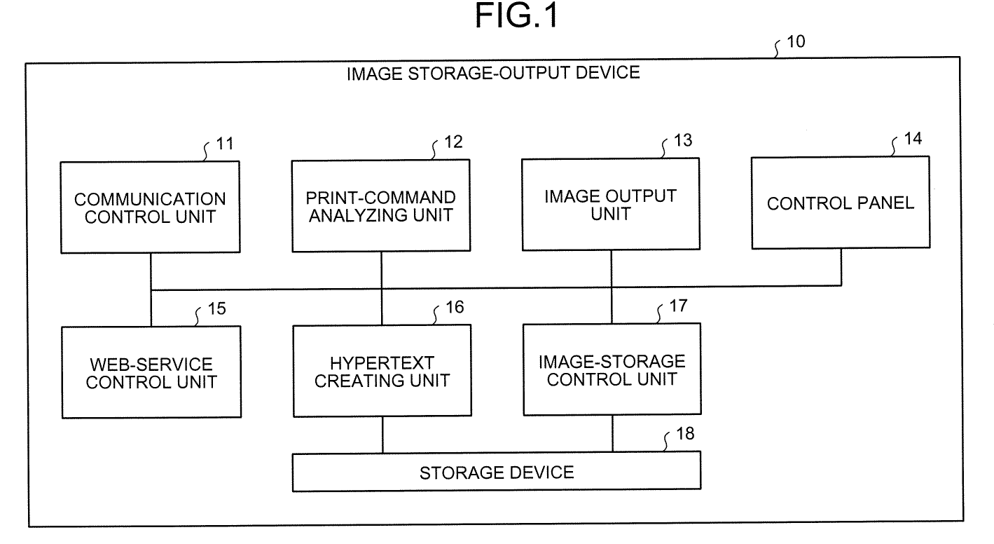

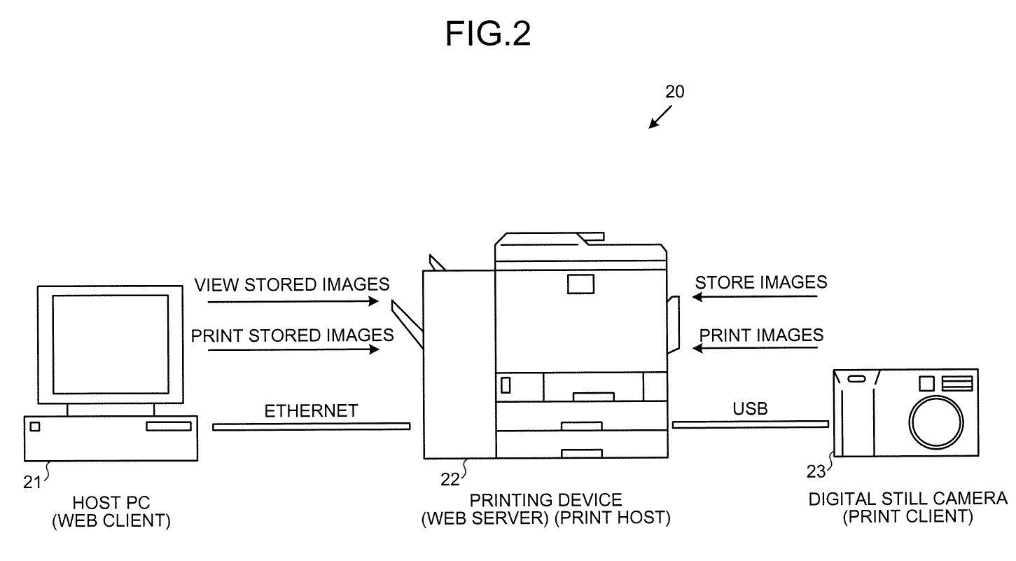

FIG. 1 is a block diagram of an image storage device used in the image storage system and the image forming system according to an embodiment of the present invention. FIG. 2 is a schematic for explaining the image storage system and the image forming system in which the image storage device shown in FIG. 1 is configured as a printing device. The image storage device shown in FIG. 1 is referred to as an image storage-output device 10 because, when an external storage device (for example, a digital still camera) is connected to it, a storage device 18 provided therein stores/manages image data received from the external storage device or an image output unit 13 provided therein prints the image data received from the external storage device.

The image storage-output device 10 includes a communication control unit 11, a print-command analyzing unit 12, the image output unit 13, a control panel 14, a Web-service control unit 15, a hypertext creating unit 16, an image-storage control unit 17, and the storage device 18.

The communication control unit 11 is connected to the external storage device such as a digital still camera by a Universal Serial Bus (USB) and performs communication control to enable direct printing using a specific communication format (for example, PictBridge®).

The print-command analyzing unit 12 analyzes a print command issued in the specific communication format by the external storage device such as the digital still camera.

The image output unit 13 prints out the image data received from the external storage device such as the digital still camera on a printing medium such as a sheet of paper.

The control panel 14 enables the user to issue instructions to store/manage or print on a sheet of paper the image data received by the image storage-output device 10 from the external storage device.

The Web-service control unit 15 enables the image storage-output device 10 to function as a Web server by connecting the image storage-output device 10 to an external host device, described later, over a network such as the Ethernet.

The hypertext creating unit 16 creates hypertext links, associating each image data with its storage location when storing the image data in the storage device 18.

The image-storage control unit 17 performs a storage control process when storing the image data in the storage device 18. For example, when storing the image data in the storage device 18, the image-storage control unit 17 performs the storage control process according to a printing process procedure of the print command analyzed by the print-command analyzing unit 12.

The storage device 18 stores therein the image data received from the external storage device. The storage device 18 can be a large-capacity hard disk drive (HDD).

The image storage-output device 10 can be incorporated in a printing device 22 shown in FIG. 2. In the system configuration shown in FIG. 2, the image storage-output device 10 that functions as the printing device 22 is directly connected to a digital still camera 23 via the USB. A host PC 21 that functions as the external host device is connected to the printing device 22 over the Ethernet.

In an image storage system (or an image forming system) 20 thus configured, the image data captured and stored in a memory card by the digital still camera 23 can be directly sent to the printing device 22 using a specific communication format (such as the PictBridge®) that enables direct printing.

The digital still camera 23 shown in FIG. 2 is equipped with an imaging device that captures images, a monitor device that displays the captured images, a storage device such as a memory card that stores the captured digital image, and a communication control unit that controls the communication between the digital still camera 23 and an external device via a general-purpose interface. The USB directly connects the digital still camera 23 and the printing device 22, enabling the image data stored in the storage device of the digital still camera 23 to be directly output to the printing device 22 by exchanging a specific communication format.

Thus, the image storage system (or the image forming system) 20 is configured by a direct printing system in which the digital still camera 23 and the printing device 22 are directly connected. The working of the image storage system (or the image forming system) 20 is described below.

The transferring the digital data stored in the storage device of the digital still camera 23 to the printing device 22 imitates the printing process employed when directly printing the image data from the digital still camera 23. That is, unlike in direct printing when the image data from the digital still camera 23 is directly printed, the print command in the specific communication format such as the PictBridge® is analyzed, and the image data received from the digital still camera 23 is stored in the storage device 18 by imitating the printing process procedure of the print command. By patterning the storage process after the printing process, the image data from the digital still camera 23 can be appropriately stored in the storage device 18 represented by a large-capacity HDD.

Imitating the printing process during direct printing specifically refers to the communication between the digital still camera 23 and the printing device 22 in the form of “response to a print service request”, “response to a device capability information request”, “print command analysis”, “image file request process based on analysis result”, “notification of printing status”, “notification of printing completion”, etc.

When storing the image data in the storage device 18 of the printing device 22, a directory for storing the image data is automatically created and the image data is stored in the directory. The hypertext creating unit 16 (see FIG. 1) creates the hypertext links, associating each image data with its storage location.

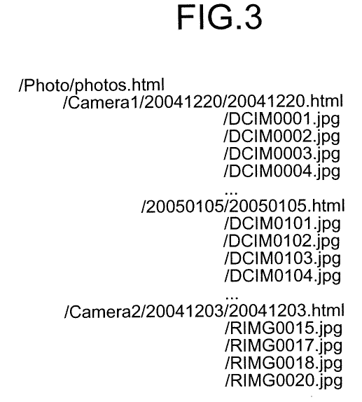

FIG. 3 is a drawing of file structure in a directory where the image data is stored. The auto-generated directory structure is made of the name of the camera that is connected, the download date etc. The file arrangement in the directory is as shown in FIG. 3.

As shown in FIG. 3, directories corresponding to each camera connected is created in a top directory “Photo”, and a “photos.html” that links to an html document associating every image stored by the print command from the digital still camera is also created.

The “photos.html” link is updated every time the digital still camera 23 issues a print command to the printing device 22 and the image data is stored in the printing device 22 and an html document is created under a new directory.

The printing device 22 can also be made to function like a Web server. Thus, a Web browser (such as the Internet Explorer®) can be used to easily view the html documents on the host PC 21 connected to the printing device 22 over a network such as the Ethernet by the general-purpose interface.

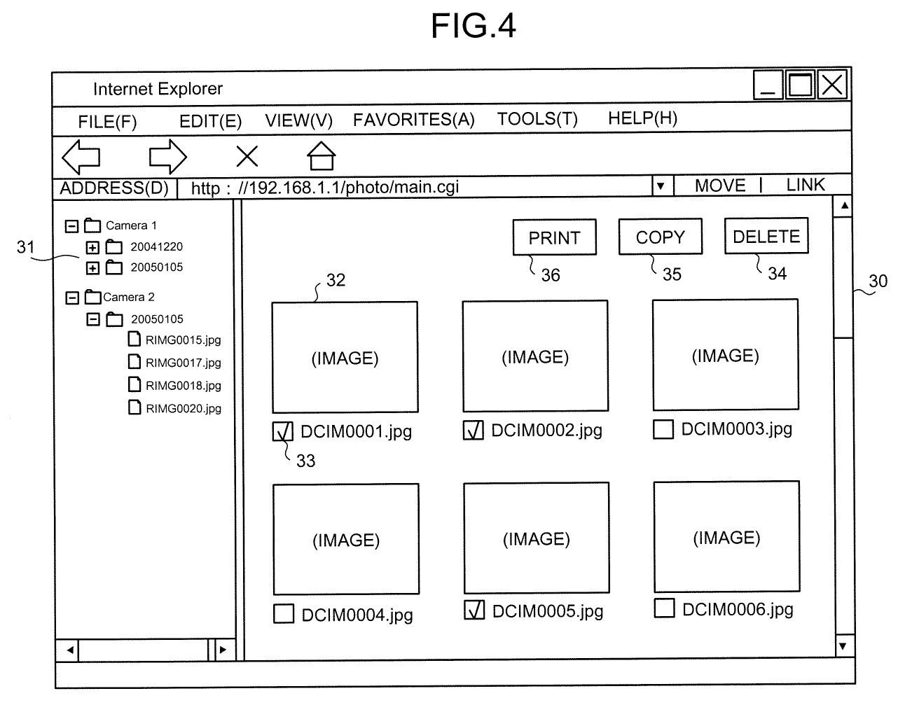

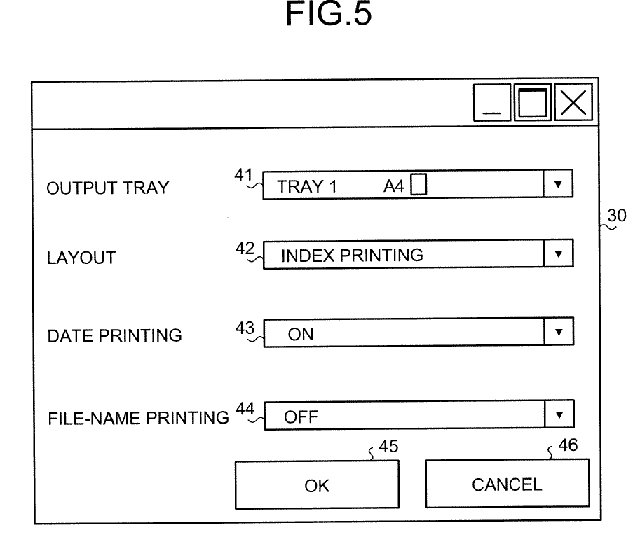

FIG. 4 is a drawing of a display screen of the host PC displaying the html document that can be viewed using a Web client. FIG. 5 is a drawing of a print setup screen that is displayed upon clicking the Print button in the display screen shown in FIG. 4. The html documents stored in the storage device 18 of the printing device 22 can be viewed easily using the Web client (the Internet Explorer®) of the host PC 21 as shown in FIG. 4 by accessing a specific URL in the printing device 22 containing the directory structure described above from the Web client (of the host PC 21).

A frame 31 on the left side of a display screen 30 in FIG. 4 displays the directory structure created when saving image data in the printing device 22 in the past in the “photos.html” shown in FIG. 3. The frame on the right side of the display screen 30 in FIG. 4 displays images 32 saved in the html document in the selected directory.

A check box 33 is provided below each image in the frame on the right side. An image from the printing device 22 can be deleted by selecting the check box 33 provided below the image and clicking a Delete button 34 provided on the upper right of the display screen 30. When the concerned image data is deleted from the storage device 18 of the printing device 22, and the html document corresponding to the relevant directory gets updated.

The same procedure can be followed for copying an image stored in the printing device 22. An image can be copied by selecting the check box 33 of the concerned image and clicking a Copy button provided on the upper right of the display screen 30. The selected image can be moved to another directory within the storage device 18 of the printing device 22 or copied to a local memory of the host PC 21 connected to the printing device 22. When the selected image is copied to another directory in the storage device 18, the concerned html file in the directory in the storage device 18 is updated.

In the present embodiment, as shown in FIGS. 1 and 2, the image storage-output device 10 (the printing device 22) includes the image output unit 13 that outputs the image data and the storage device 18. However, a device including only the storage device 18 and no image output unit 13 present can also be realized. However, such a device including only the storage device 18 should preferably be always powered on and connected to the network, like printers and copiers in an office environment. As such a device is always powered on and is connected to the network, an unspecified number of host PCs connected to the network can access the device anytime and view the image data stored in the device, enhancing convenience.

By providing a device that not only just stores and manages image data, but prints out the image data on a sheet of paper, enabling the host PC 21 connected to the network to view the image data stored in the storage device 18 using a Web client and print the image data. This obviates the need for installing applications or printer drivers in the host PC 21 and allows print output anytime. Thus, the image data stored in the storage device 18 can be reused easily, allowing the images to be utilized more effectively.

Using the Web client of the host PC 21, an image can be printed by selecting the check box 33 provided below the image 32 and clicking a Print button 36 provided on the upper right of the display screen 30. Upon clicking the Print button 36 the display screen 30 shown in FIG. 5 will be displayed for print setup. Clicking an OK button 45 in the display screen 30 creates a printing job in the printing device 22, and the selected image is printed out.

The display screen 30 shown in FIG. 5 includes an output tray selection box 41, a layout selection box 42, a date printing option selection box 43, and a file-name printing option selection box 44. The output tray selection box 41 accepts selection of the tray from which the sheet of paper is to be drawn for printing. The layout selection box 42 accepts specification of the layout of the printout. In the example shown in FIG. 5, index printing has been selected. The date printing option selection box 43 accepts selection of whether date printing is to be turned on or off. Similarly, the file-name printing option selection box 44 accepts selection of whether file name printing is to be turned on or off. Once these selections are made, printing can be started by clicking the OK button 45 or abandoned by clicking a Cancel button 46 in the display screen 30.

Thus, image data stored in the storage device 18 of the printing device 22 can be viewed and printed anytime from the host PC 21 connected to the network, and the need for installing applications or printer drivers, etc. is obviated. Therefore, by ensuring easy operation anytime, easy storage and printing of the image data is enabled without having to use office PCs that are likely to have restrictions on installation of software.

Further, as the present embodiment is implemented on the printing device 22 that includes the image output unit 13, direct output of image by direct printing can be realized by directly connecting the digital still camera 23 and the printing device 22. The printing device 22 in the form of a printer or a copier can be configured to have a selection button on the control panel 14 enabling selection of whether, when the digital still camera 23 is connected to the printing device 22, the image data from the digital still camera 23 is to be printed out or stored in the storage device 18.

Thus, provision of the selection button on the control panel 14 of the printing device 22 enables the user to select whether, when the digital still camera 23 is connected to the printing device 22, the image data from the digital still camera 23 is to be printed out or stored in the storage device 18 and made available for viewing from an external device, such as the host PC 21 over the network.

According to an aspect of the present invention, the hypertext links are created when storing image data, so that the image data can be systematically managed making it convenient for searching or reusing the image data. Moreover, image data can be stored/managed without having to use office PCs. Furthermore, image data can be easily viewed using the Web browser of the external host device, obviating the need for any specific applications for viewing the image data, and reducing the burden of application management.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image storage system that includes an external storage device that stores therein image data and outputs the image data, and an image storage device that stores therein the image data received from the external storage device by exchanging a specific communication format when the external storage device and the image storage device are directly connected, wherein
the image storage device includes
a communication control unit that controls communication between the image storage device and the external storage device;
a storage unit that stores therein image data received from the external storage device through the communication control unit; and
a hypertext creating unit that creates hypertext links associating each image data and a storage location of the image data when storing the image data received from the external storage device in the storage unit.

2. The image storage system according to claim 1, wherein the external storage device is directly connected to the image storage device, wherein the image storage device further includes:
a print-command analyzing unit that analyzes a print command issued in the specific communication format by the external storage device; and
an image-storage control unit that stores the image data received from the external storage device in the storage unit according to a printing process procedure of the print command analyzed by the print-command analyzing unit.

3. The image storage system according to claim 1, wherein the image storage device further includes a Web-service control unit that
connects the image storage device and an external host device over a network and enables the image storage device to function like a Web server, and
provides, upon request from a Web client of the external host device, the hypertext links created when storing the image data in the storage unit to the Web client of the external host device.

4. The image storage system according to claim 3, wherein the image storage device enables deletion of an arbitrary image data stored in the storage unit upon request from the Web client of the external host device.

5. The image storage system according to claim 3, wherein the image storage device enables copying of an arbitrary image data stored in the storage unit upon request from the Web client of the external host device.

6. The image storage system according to claim 1, wherein the external storage device is a digital still camera that is directly connected to the image storage device by a communication unit that enables communication between the digital still camera and the image storage device using the specific communication format, and the external storage device includes
an image capturing unit that captures images; and
a storage unit that stores therein the images captured by the image capturing unit.

7. An image forming system that includes an image storage system that includes
an external storage device that stores therein image data and outputs the image data; and
an image storage device that stores therein the image data received from the external storage device by exchanging a specific communication format when the external storage device and the image storage device are directly connected, the external storage device being directly connected to the image storage device, wherein the image storage device includes
a communication control unit that controls communication between the image storage device and the external storage device;
a storage unit that stores therein image data received from the external storage device through the communication control unit;
a hypertext creating unit that creates hypertext links associating each image data and a storage location of the image data when storing the image data received from the external storage device in the storage unit;
a print-command analyzing unit that analyzes a print command issued in the specific communication format by the external storage device;
an image-storage control unit that stores the image data received from the external storage device in the storage unit according to a printing process procedure of the print command analyzed by the print-command analyzing unit; and
an image output unit that prints out the image data received from the external storage device,
wherein the print-command analyzing unit analyzes the print command issued in the specific communication format by the external storage device and the image output unit prints out the image data received from the external storage device.

8. The image forming system according to claim 7, wherein the image storage device further includes a control panel that allows a user to select whether the image data received from the external storage device is to be stored in the storage unit of the image storage device or output by the image output unit, wherein
after direct connection of the image storage device and the external storage device is established, the user can use the control panel to select between storing the image data and printing out the image data.

9. The image forming system according to claim 7, wherein the external storage device is a digital still camera that is directly connected to the image storage device by a communication unit that enables communication between the digital still camera and the image storage device using the specific communication format, and includes,
an image capturing unit that captures images, and
a storage unit that stores the images captured by the image capturing unit.

10. An image forming system that includes an image storage system that includes
an external storage device that stores therein image data and outputs the image data; and
an image storage device that stores therein the image data received from the external storage device by exchanging a specific communication format when the external storage device and the image storage device are directly connected, the external storage device being directly connected to the image storage device, wherein the image storage device includes
a communication control unit that controls communication between the image storage device and the external storage device;
a storage unit that stores therein image data received from the external storage device through the communication control unit;
a hypertext creating unit that creates hypertext links associating each image data and a storage location of the image data when storing the image data received from the external storage device in the storage unit;
a print-command analyzing unit that analyzes a print command issued in the specific communication format by the external storage device;
an image-storage control unit that stores the image data received from the external storage device in the storage unit according to a printing process procedure of the print command analyzed by the print-command analyzing unit;
an image output unit that outputs the image data received from the external storage device; and
a Web-service control unit that
connects the image storage device and an external host device over a network and enables the image storage device to function like a Web server, and
provides, upon request from a Web client of the external host device, the hypertext links created when storing the image data in the storage unit to the Web client of the external host device,
wherein an arbitrary image data stored in the storage unit can be directly output by the image output unit upon request from the Web server of the external host device.

11. The image forming system according to claim 10, wherein the external storage device is a digital still camera that is directly connected to the image storage device by a communication unit that enables communication between the digital still camera and the image storage device using the specific communication format, and includes,
an image capturing unit that captures images, and
a storage unit that stores the images captured by the image capturing unit.
